(19) United States
(12) Patent Application Publication
(10) Pub. No.: US 2007/0288477 A1
(43) Pub. Date: Dec. 13, 2007

(54) Information processing apparatus, information processing system, information processing method, and computer program

(76) Inventor: Junichi Rekimoto, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/712,374

(22) Filed: Mar. 1, 2007

(30) Foreign Application Priority Data
Mar. 2, 2006 (JP) 2006-056682

(51) Int. Cl. G06F 17/30; G06F 3/00

(52) U.S. Cl. 707/10; 715/700

(57) ABSTRACT

An information processing apparatus includes a user interface serving as a data input/output unit, a communicating unit that executes data communication, and a data processing unit that executes bookmark setting processing serving as Web page browsing processing and URL (Uniform Resource Locator) registration processing of a Web page. The data processing unit acquires and executes a function corresponding to an attribute name that is an element of an extended tag including a combination of an attribute name and an attribute value set as index information corresponding to a bookmark or acquires an execution result of the function corresponding to the attribute name and outputs the execution result of the function to the user interface.

### CROSS-REFERENCES TO RELATED APPLICATIONS

The present invention contains subject matter related to Japanese Patent Application JP 2006-056682 filed in the Japanese Patent Office on Mar. 2, 2006, the entire contents of which being incorporated herein by reference.

### BACKGROUND OF THE INVENTION

1. Field of the Invention

The present invention relates to an information processing apparatus, an information processing system, an information processing method, and a computer program. More particularly, the present invention relates to an information processing apparatus, an information processing system, an information processing method, and a computer program that realize improvement of usability of tags that can be set in association with resources on a network.

2. Description of the Related Art

Recently, network communication via the Internet and the like is popular and various services are provided via networks. Users can acquire various kinds of information from servers, computers, and the like connected to the networks.

For example, as one of the services via the networks, there is a search service. The search service is a service in which a search server receives a search request from a user terminal such as a network-connected computer or portable terminal, executes processing corresponding to the search request, and transmits a processing result to the user terminal.

For example, when search processing via the Internet is executed, a user accesses a site that provides a search service, inputs search conditions such as a keyword, a category, and the like in accordance with menus presented on the site, and transmits the search conditions to a server. The server executes the processing in accordance with the search conditions and displays a processing result on a user terminal.

In order to classify and sort out information obtained by such search service, i.e., resources on the network (files, photographs, Web site URLs (Uniform Resource Locators), etc.), the user can attach “tags” to the resources and sort out the resources. For example, the user can set acquired Web pages and the like as registration information such as “bookmarks” or “favorites” and set “tags” such as keywords that allow the user to immediately judge what kind of information these pieces of information are. The tags are usually keywords. For example, tags such as “Travel” and “Party” are attached to photographs and tags such as “News”, “Blog”, “Movie”, and “Review” are attached to the bookmarks of the Web pages. These tags serve as clues for information search and means for sharing the resources with others.

When registration information such as “bookmarks” or “favorites” and “tags” serving as keywords are accumulated in the server as shared information that plural users can browse, for example, users having similar hobbies and interests can efficiently share information. Specifically, when plural Web pages to which plural users attach the same tag name (e.g., Tokyo) are formed as one group, it is possible to efficiently categorize the Web pages. Such information sharing services are provided by various network service providing entities and information search service providing entities.

As a general information classifying method, there is a method of classifying information by hierarchizing, like a tree structure, the information as main items and intermediate items in accordance with single classification items. Compared with such an information classifying method, a method of classifying information by attaching keywords such as tags to the information has an advantage that it is possible to sort out information from plural different viewpoints. For example, for a Web page of a certain shop, a user can arbitrarily set tags from completely different viewpoints such as a tag corresponding to a location and a tag corresponding to a type of the shop. It is unnecessary to design hierarchies of classifications in advance. The user can freely devise and use new tag names.

For example, according to tags such as “Travel”, “Tokyo”, and “Weather”, it is possible to set “Tokyo” and “Weather” as tags for information on the weather in Tokyo and attach the tags “Tokyo” and “Travel” to information on the travel in Tokyo. In such setting of tags, it is unnecessary to define a hierarchical relation for the respective tags “Tokyo”, “Weather”, and “Travel”. The user can freely set tags and efficiently classify information.

Such information classification processing based on tags is compatible with communication services on the network. For example, a network service called “social bookmark service” provides a service for facilitating communities of users who set bookmarks on the same Web page and connection among users who use the same tags by sharing bookmarks, which are managed on a Web browser side of each individual in the past, with other users on the network.

However, tags usually used in such a network service are keywords (words). Although the tags are effective as described above when the tags are applied to classification of information, a large number of tags are necessary for expressing concepts with the tags more in depth than the classification processing. Further, it is difficult to categorize various kinds of information, on which tags of different character strings and numerical value strings are set, as related information.

A specific example is explained. Assuming that there is a We site that provides related information of a certain restaurant, when this Web site is registered as a bookmark, a user can leave an “address”, “evaluation of the restaurant”, a “telephone number”, and the like as tag information corresponding to this Web site. Specifically, for example, the user attaches the following tags.

A tag indicating the address: 3-14-aa, Higasi-Gotanda Shinagawa-ku, Tokyo

A tag indicating the telephone number: 03-55x8-44y0

However, even if the user who sets the tags can understand meanings of the tags, it may be sometimes impossible for other users to immediately understand that these tags mean the address and the telephone number of the restaurant. It is also likely it is difficult for the user who sets the tags to understand the meaning of the tags after several months. When such tags, which people feel difficulty in understanding, are set by a large number of users, a large quantity of tags with low usability are set. As a result, effective sharing of information and efficient information search are hindered. Such an address and a telephone number are information corresponding only to one specific Web page. When “grouping processing for Web pages attached with the same tag” is performed in the social bookmark service, it is difficult to use the information to processing such as categorization of the information.

Since the tag of the telephone umber 03-5xx8-4yy0 is a simple keyword, information indicating that this is a telephone number is not explicitly represented. For example, as information assumed to be tags that can be represented as numerical values, other than the telephone number, there are various kinds of information such as latitude and longitude information, ranking information, the number of visitors, and the number of registered users. When a numerical value string is registered as a tag, it is difficult to immediately judge a meaning of the numerical value. Therefore, even if such tags are attached to bookmarks, it is difficult to effectively use these numerical value tags as clues for search.

On the other hand, it is also possible to determine item names such as “address” and “telephone” in advance as in the database in the past and set a value for each of the items. However, when such setting is performed, a user can use only specific items that a system designer allows users to set in advance anticipating that the items would be used. It is difficult for the user to freely introduce new tag names.

### SUMMARY OF THE INVENTION

Therefore, it is desirable to provide an information processing apparatus, an information processing system, an information processing method, and a computer program that extend functions of tags that can be set in association with resources on a network and realize improvement of usability of the tags.

Moreover, it is desirable to provide an information processing apparatus, an information processing system, an information processing method, and a computer program that realize a mechanism for attaching meta-information with higher functions while naturally expanding a framework of social communication in the past by extending tags to allow use of not only keywords in the past but also tabs of an attribute name/attribute value type.

According to a first embodiment of the invention there is provided an information processing apparatus including: a user interface serving as a data input/output unit; a communicating unit that executes data communication; and a data processing unit that executes bookmark setting processing serving as Web page browsing processing and URL (Uniform Resource Locator) registration processing of a Web page. The data processing unit acquires and executes a function corresponding to an attribute name that is an element of an extended tag including a combination of an attribute name and an attribute value set as index information corresponding to a bookmark or acquires an execution result of the function corresponding to the attribute name and outputs the execution result of the function to the user interface.

In the information processing apparatus, the data processing unit transmits extended tag structure information, which is inputted or designated via the user interface, to a server via the communicating unit, receives a function, which is registered as an attribute-name-corresponding function in a function registration table held by the server, from the server via the communicating unit and executes the function, and outputs an execution result of the function to the user interface.

In the information processing apparatus, the data processing unit executes processing for transmitting extended tag structure information, which is inputted or designated via the user interface, to a server via the communicating unit, receiving an execution result of a function, which is registered as an attribute-name-corresponding function in a function registration table held by the server, from the server via the communicating unit, and outputting the function execution result received to the user interface.

In the information processing apparatus, the data processing unit executes a function set in association with an attribute name in an extended tag by applying an attribute value in the extended tag to the function or acquires a function execution result obtained by executing the function by applying the attribute value in the extended tag to the function and outputs the function execution result to the user interface.

In the information processing apparatus, the data processing unit executes, on the basis of user input information corresponding to information presented on the user interface as the function execution result, processing for displaying information corresponding to the user input on the user interface.

In the information processing apparatus, the information displayed on the user interface in association with the user input is attribute-value-setting-support information at the time of setting of a new extended tag.

According to a second embodiment of the invention, there is provided an information processing apparatus including: a storing unit having stored therein a bookmark serving as URL (Uniform Resource Locator) registration information of a Web page, registration information of an extended tag that is index information corresponding to the bookmark and includes a combination of an attribute name and an attribute value, and a function registration table in which a function corresponding to the attribute name is registered; a communicating unit that executes data communication; and a data processing unit that executes processing for presenting the bookmark and a list of extended tags in response to a client request received via the communicating unit. The data processing unit inputs extended tag structure information from a client, acquires, on the basis of an attribute name included in the extended tag structure information, a registered function corresponding to the attribute name from the function registration table, and outputs the function acquired or a function execution result obtained by executing the function acquired to the client via the communicating unit.

In the information processing apparatus, the data processing unit executes, in executing the registered function corresponding to the attribute name acquired from the function registration table, the registered function as function execution processing to which an attribute value in the extended tag structure information received from the client is applied.

According to a third embodiment of the invention, there is provided an information processing system including a client and a server that are capable of performing data communication with each other. A data processing unit of the client executes processing for transmitting structure information of an extended tag including a combination of an attribute name and an attribute value set as index information corresponding to a bookmark serving as URL (Uniform Resource Locator) registration information of a Web page to a server via a client communicating unit. A data processing unit of the server executes processing for acquiring, on the basis of the attribute name included in the extended tag structure information received from the client, a registered function corresponding to the attribute name from a function registration table in which an attribute name and a corresponding function stored in a server storing unit are registered and outputting the function acquired or a function execution result obtained by executing the function acquired to the client via a server communicating unit. The data processing unit of the client executes processing for outputting a function execution result obtained by executing the function received from the server or the function execution result received from the server to a user interface on the client side.

According to a fourth embodiment of the invention, there is provided a data structure of an extended tag including a combination of an attribute name and an attribute value set as index information corresponding to a bookmark serving as URL (Uniform Resource Locator) registration information of a Web page. The attribute name is information applied to selection of a function registered in association with the attribute name in a data processing unit in an information processing apparatus. The attribute value is a value having an attribute defined by the attribute name and is a value applied when the data processing unit executes the function registered in association with the attribute name.

According to a fifth embodiment of the invention, there is provided an information processing method executed in an information processing apparatus. The information processing method includes the steps of: performing, in a data processing unit, function acquisition execution processing for acquiring and executing a function corresponding to an attribute name that is an element of an extended tag including a combination of an attribute name and an attribute value set as index information corresponding to a bookmark serving as URL (Uniform Resource Locator) registration information of a Web page or function execution result acquisition processing for performing acquisition of an execution result of the function corresponding to the attribute name; and outputting, in the data processing unit, the function execution result to a user interface.

In the information processing method, the function processing step includes the steps of: transmitting extended tag structure information inputted or designated via the user interface to a server via a communicating unit; and receiving a function registered as an attribute-name-corresponding function in a function registration table held by the server from the server via the communicating unit and executing the function.

In the information processing method, the function processing step includes the steps of: transmitting extended tag structure information inputted or designated via the user interface to a server via a communicating unit; and receiving an execution result of a function registered as an attribute-name-corresponding function in a function registration table held by the server from the server via the communicating unit.

In the information processing method, the function processing step is a step of executing a function set in association with the attribute name in the extended tag by applying the attribute value in the extended tag to the function or acquiring a function execution result obtained by executing the function by applying the attribute value in the extended tag to the function.

The information processing method further includes the step of executing, in the data processing unit, on the basis of user input information corresponding to information presented on the user interface as the function execution result, processing for displaying information corresponding to the user input on the user interface.

In the information processing method, the information displayed in association with the user input on the user interface is attribute-value-setting-support information at the time of setting of a new extended tag.

According to a sixth embodiment of the invention, there is provided an information processing method executed in an information processing apparatus. The information processing method includes the steps of: inputting, in a communicating unit, extended tag structure information including a combination of an attribute name and an attribute value as index information corresponding to a bookmark serving as URL (Uniform Resource Locator) registration information of a Web page from a client; and executing, in a data processing unit, processing for acquiring, on the basis of the attribute name included in the extended tag structure information, a registered function corresponding to the attribute name from a function registration table in which an attribute name and a corresponding function stored in a storing unit are registered and outputting the function acquired or a function execution result obtained by executing the function acquired to the client via the communicating unit.

In the information processing method, the function processing step is a step of, in executing the registered function corresponding to the attribute name acquired from the function registration table, executing the registered function as function execution processing to which the attribute value in the extended tag structure information received from the client is applied.

According to a seventh embodiment of the invention, there is provided a computer program that causes an information processing apparatus to execute information processing. The computer program causes the information processing apparatus to execute the steps of: performing, in a data processing unit, function acquisition execution processing for acquiring and executing a function corresponding to an attribute name that is an element of an extended tag including a combination of an attribute name and an attribute value set as index information corresponding to a bookmark serving as URL (Uniform Resource Locator) registration information of a Web page or function execution result acquisition processing for performing acquisition of an execution result of the function corresponding to the attribute name; and outputting, in the data processing unit, the function execution result to a user interface.

According to an eighth embodiment of the invention, there is provided a computer program that causes an information processing apparatus to execute information processing. The computer program causes the information processing apparatus to execute the steps of: inputting, in a communicating unit, extended tag structure information including a combination of an attribute name and an attribute value as index information corresponding to a bookmark serving as URL (Uniform Resource Locator) registration information of a Web page from a client; and executing, in a data processing unit, processing for acquiring, on the basis of the attribute name included in the extended tag structure information, a registered function corresponding to the attribute name from a function registration table in which an attribute name and a corresponding function stored in a storing unit are registered and outputting the function acquired or a function execution result obtained by executing the function acquired to the client via the communicating unit.

The computer program according to the embodiment of the invention is, for example, a computer program that can be provided to a computer system, which is capable of executing various program codes, by a storage medium or a communication medium provided in a computer-readable format, for example, a recording medium such as a CD, an FD, or an MO or a communication medium such as a network. By providing such a computer program in a computer-readable format, processing corresponding to the computer program is realized on the computer system.

Further objects, characteristics, and advantages of the invention will be made apparent through more detailed explanations based on embodiments of the invention described later and the attached drawings. In this specification, a system means a logical collection of plural apparatuses and is not limited to a system in which apparatuses of various structures are stored in an identical housing.

According to the embodiments of the invention, an extended tag (Richtag) including a combination of an attribute name (a tag name) and an attribute value (a tag value) is used as index information corresponding to a bookmark serving as URL (Uniform Resource Locator) registration information of a Web page, a function corresponding to the attribute name that is an element of the extended tag is set and registered, and a function corresponding to an attribute name designated by a user is acquired and executed. Consequently, it is possible to perform; for example, processing for displaying a map corresponding to latitude and longitude information set as an attribute name with respect to an attribute name [location] indicating a location and processing for acquiring and displaying an image corresponding to an image information address (URL (Uniform Resource Locator)) set as an attribute value with respect to an attribute name [image] indicating image information.

### BRIEF DESCRIPTION OF THE DRAWINGS

FIG. 1 is a network diagram showing an example of application of an information processing system according to an embodiment of the invention;

FIG. 2 is a diagram for explaining an example of structures of a client and an information sharing server constituting the information processing system according to the embodiment;

FIGS. 3A and 3B are diagrams for explaining an example of a structure of a function registration table;

FIG. 4 is a diagram for explaining an example of processing of a function associated with an attribute name of an extended tag;

FIG. 5 is a diagram for explaining an example of processing of a function associated with an attribute name of an extended tag;

FIG. 6 is a diagram for explaining an example of a communication sequence between the client and the information sharing server at the time when the processing of a function associated with an attribute name of an extended tag is executed;

FIG. 7 is a diagram showing an example of a bookmark list;

FIG. 8 is a diagram showing an example of execution of a function based on an extended tag included in the bookmark list;

FIG. 9 is a diagram showing an example of execution of a function based on an extended tag included in the bookmark list;

FIG. 10 is a diagram for explaining an example of a communication sequence between the client and the information sharing server at the time when the processing of a function associated with an attribute name of an extended tag is executed;

FIG. 11 is a diagram for explaining an example of a sequence of processing for registering an extended tag;

FIG. 12 is a diagram for explaining an example of a communication sequence between the client and the information sharing server at the time when function processing is executed in processing for registering an extended tag;

FIG. 13 is a diagram for explaining the processing for registering an extended tag;

FIG. 14 is a diagram showing an example of structures of a bookmark-and-extended-tag-registration page;

FIG. 15 is a diagram showing an example of use of a bookmark-and-extended-tag-registration page and function processing;

FIG. 16 is a diagram showing an example of use of a bookmark-and-extended-tag-registration page and function processing;

FIG. 17 is a diagram showing an example of use of a bookmark-and-extended-tag-registration page and function processing;

FIG. 18 is a diagram for explaining an example of a communication sequence between the client and the information sharing server at the time when function processing is executed in processing for registering an extended tag; and

FIG. 19 is a diagram for explaining an example of a hardware structure of an information processing apparatus used in the information processing system.

### DESCRIPTION OF THE PREFERRED EMBODIMENTS

Embodiments of the invention will be hereinafter explained in detail with reference to the accompanying drawings.

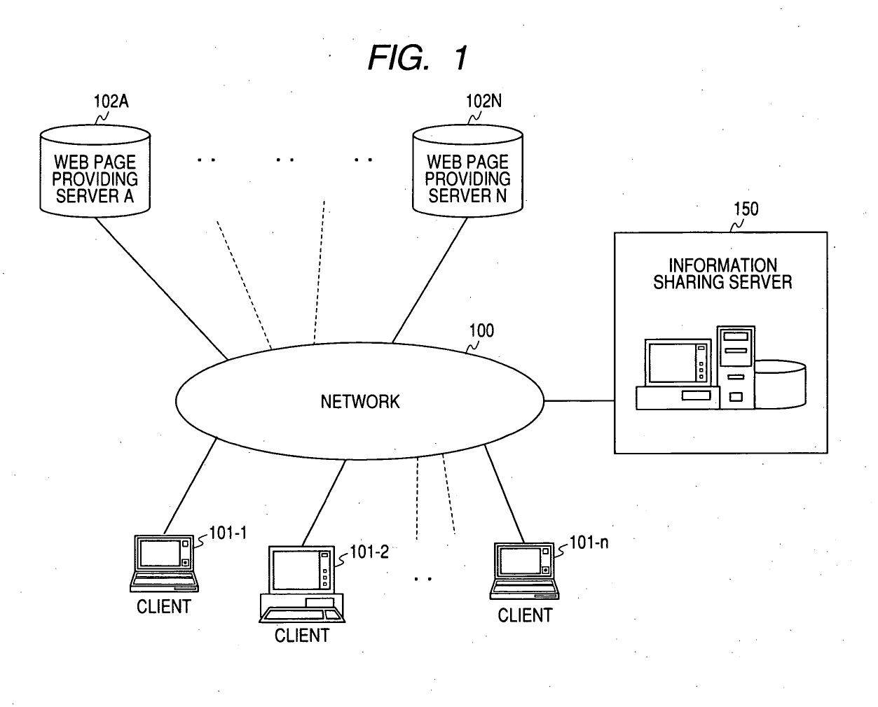

First, an example of a form of use of an information processing system according to an embodiment of the invention will be explained with reference to FIG. 1. A network 100 shown in FIG. 1 is a network such as the Internet or an intranet. Various Web page providing servers 102A to 102N that provide Web pages, clients 101-1 to 101-n serving as user terminals that perform collection of information via the network, and an information sharing server 150 that is set as a server provided for realizing sharing of the information collected by the clients 101-1 to 101-n are connected to the network 100.

The clients 101-1 to 101-n acquire, for example, various kinds of information (resources) via the network. The resources include files, photographs, and Web site URLs (Uniform Resource Locators). The clients 101-1 to 101-n attach “tags” to the resources acquired (files, photographs, Web site URLs, etc.) to sort out the resources. In other words, the clients 101-1 to 101-n set the acquired Web pages and the like as registration information such as “bookmarks” or “favorites”. Moreover, the clients 101-1 to 101-n set “tags” such as keywords for allowing users to immediately judge what kind of information these kinds of information (resources) are.

It is possible to manage the registration information such as the “bookmarks” and the “tags” corresponding to the resources on the side of Web browser in each of the clients 101-1 to 101-n. However, the clients 101-1 to 101-n can provide the information sharing server 150 with these kinds of registration information and set the registration information as shared information. In the information sharing server 150, resource information (bookmarks) registered by a large number of users and index information (tags) corresponding to the resource information are registered. The clients 101-1 to 101-n can use these kinds of information as shared information. The clients 101-1 to 101-n can efficiently acquire necessary information by acquiring and browsing the resource information and the tag information registered in the information sharing server 150.

The tags set in the past as the index information set on the resources (files, photographs, Web site URLs, etc.) are so-called keywords. The tags are set as words such as “Travel”, “Tokyo”, and “Weather”.

In this embodiment, instead of being formed as only the keywords in the past, the tags are formed as extended tags of a [attribute name (tag name)]:[attribute value (tag value): type in the past to realize improvement of usability of the tags. In other words, a mechanism for attaching meta-information with higher function using the tags is realized.

A structure of a tag used in this embodiment has a data format of [attribute name (tag name)]:[attribute value (tag value)]. The tag having this format is hereinafter referred to as an extended tag (Richtag).

A specific example of a structure of the extended tag will be explained. As an example of a combination of [attribute name (tag name)]:[attribute value (tag value)], for example, there are following examples.

(1) Location:135.00, 39.00

(2) ISBN:000111222

(3) phone:03-5448-4380

(4) author:Jun Rekimoto

(5) date:2006/01/21

(6) area:Gotanda

(7) rank:5

(8) mail:foo@mailhost.com

(9) ref:http://other.com/another.html

(10) image:http://aaa.bbb.com/photo.jpg

(1) Location:135.00, 39.00

This extended tag is an extended tag indicating a location and is set as follows.

[attribute name (tag name)]=[Location]

[attribute value (tag value)]=[135.00, 39.00]

In [attribute value (tag value)], latitude and longitude information indicating a location corresponding to a resource on which the tag is set is recorded.

(2) ISBN:000111222

This extended tag is an extended tag indicating a book number and is set as follows.

[attribute name (tag name)]=[ISBN]

[attribute value (tag value)]=[000111222]

In [attribute value (tag value)], a book number (an ISBN number) serving as book identification information managed by a predetermined book management organization, i.e., a book number (an ISBN number) corresponding to a resource on which the tag is set is recorded.

(3) phone:03-5448-4380

This extended tag is an extended tag indicating a telephone number and is set as follows.

[attribute name (tag name)]=[phone]

[attribute value (tag value)]=[03-5448-4380]

In [attribute value (tag value)], a telephone number corresponding to a resource is recorded.

(4) author:Jun Rekimoto

This extended tag is an extended tag indicating an author and is set as follows:

[attribute name (tag name)]=[author]

[attribute value (tag value)]=[Jun Rekimoto]

In [attribute value (tag value)], an author name corresponding to a resource is recorded.

(5) data:2006/01/21

This extended tag is an extended tag indicating date and time and is set as follows.

[attribute name (tag name)]=[date]

[attribute value (tag value)]=[2006/01/21]

In [attribute value (tag value)], date information corresponding to a resource is recorded.

(6) area:Gotanda

This extended tag is an extended tag indicating an area and is set as follows.

[attribute name (tag name)]=[area]

[attribute value (tag value)]=[Gotanda]

In [attribute value (tag value)], an area corresponding to a resource is recorded.

(7) rank:5

This extended tag is an extended tag indicating ranking and is set as follows.

[attribute name (tag name)]=[rank]

[attribute value (tag value)]=[5]

In [attribute value (tag value)], ranking information corresponding to a resource is recorded.

(8) mail:foo@mailhost.com

This extended tag is an extended tag indicating an email address and is set as follows.

[attribute name (tag name)]=[mail]

[attribute value (tag value)]=[foo@mailhost.com]

In [attribute value (tag value)], an email address corresponding to a resource is recorded.

(9) ref:http://other.com/another.html

This extended tag is an extended tag indicating reference Web site information and is set as follows.

[attribute name (tag name)]=[ref]

[attribute value (tag value)]=[http://other.com/another.html]

In [attribute value (tag value)], a URL of a reference Web site corresponding to a resource is recorded.

(10) image:http://aaa.bbb.com/photo.jpg

This extended tag is an extended tag indicating image data and is set as follows.

[attribute name (tag name)]=[image]

[attribute value (tag value)]=[http://aaa.bbb.com/photo.jpg]

In [attribute value (tag value)], a URL corresponding to image data included in a resource or related to the resource is recorded.

In this way, a user can freely set the extended tag [Richtag] together with [attribute name (tag name)]:[attribute value (tag value)]. It is possible to use these tags by freely mixing the tags with normal tags serving as only keywords.

In the extended tag (Richtag), [attribute name (tag name)]:[attribute value (tag value)] are explicitly indicated. Thus, the following services, which are difficult in the simple social tag system in the past, are possible

### SERVICE EXAMPLE 1

This service allows a user to interpret an extended tag such as [area:area name] or [Location:latitude and longitude] is interpreted, invoke and execute a function based on the extended tag, display a map corresponding to an area or a latitude and longitude corresponding to the extended tag on a display, and search for a resource (a URL of a shop bookmarked, etc.) corresponding to the extended tag on the map displayed.

### SERVICE EXAMPLE 2

This service allows a user to interpret an extended tag such as [rank:numeral] attached to various kinds of information (resources) to measure general popularity of a certain site or interpret a bookmark including both an extended tag and a general tag such as [rank:numeral], [area:area], and [restaurant] to display restaurants in a certain area in an order of popularity among users.

### SERVICE EXAMPLE 3

This service allows a user to interpret an extended tag such as [ISBN:book number] and display a result obtained by searching through plural online bookstores.

### SERVICE EXAMPLE 4

This service allows a user to interpret an extended tag such as [date:date] and display a bookmark in a calendar format. For example, in bookmarking a Web page of a conference, an event, or a concert, the user can attach an extended tag having the structure of [date:date] and browse the bookmark in the calendar format.

### SERVICE EXAMPLE 5

This service allows a user to interpret an extended tag such as [image:http://www . . . ] and include an image as bookmark information. Similarly, it is possible to attach video, music, and the like as a tag.

It is possible to execute the services according to processing of an invoked function using an extended tag (Richtag), i.e., [attribute name (tag name)] [attribute value (tag value)]. In other words, it is possible to provide a user with various kinds of additional information by invoking a function set in advance in association with [attribute name (tag name)] of the extended tag and executing processing of the invoked function with [attribute value (tag value)] as an input parameter.

For example, the processing of the service example 1, i.e., the processing for interpreting an extended tag such as [area:area name] or [Location:latitude and longitude], executing function invocation based on the extended tag, and displaying a map corresponding to an area or a latitude and longitude corresponding to the extended tag on a display is realized as described below.

Processing by the invoked function set in association with the extended tag [Location:135.00, 39.00] is as follows.

[attribute name (tag name)]=[Location]

The invoked function set in association with this attribute name is set as a function for executing processing for acquiring and display a map. [attribute value (tag value)]=[135.00, 39.00], i.e., the latitude and longitude information is applied as a parameter for determining an area of the map acquired and displayed. Map information is acquired from a storing unit of the apparatus or a database, a server, or the like connected to the network. This data acquisition destination information is also set in a function.

Similarly, processing by the invoked function set in association with the extended tag [area:Gotanda] is as follows.

[attribute name (tag name)]=[area]

The invoked function set in association with this attribute name is set as a function for executing processing for displaying a map. [attribute value (tag value)]=[Gotanda], i.e., place name information is applied as a parameter for determining an area of the map displayed.

The processing of the service example 2, i.e., the processing for interpreting an extended tag such as [rank:numeral] to measure general popularity of a certain site or interpreting a bookmark including an extended tag and a general such as [rank:numeral], [area:area] and [restaurant] to display restaurants in a certain area in an order of popularity among users is realized as described below.

Processing by the invoked function set in association with the extended tag [rank:numeral] is as follows.

[attribute name (tag name)]=[rank]

The invoked function set in association with this attribute name is set as a function for executing processing for totaling extended tags having identical [attribute name (tag name)]=[rank] corresponding to an identical site and displaying a result of the totaling. The totaling processing in this case is executed as processing for inputting and totaling [attribute value (tag value)]=[numeral].

The ranking display of restaurant in a specific area is realized by executing search based on the extended tag and the general tag such as [area:area] and [restaurant] and then executing processing by a function corresponding to the extended tag [rank:numeral] on a result of narrowing down the search.

The processing of the service example 3, i.e., the processing for interpreting an extended tag such as [ISBN:book number] and displaying a result of searching through plural online bookstores is realized as follows.

Processing by the invoked function set in association with the extended tag [ISBN:book number] is as follows.

[attribute name (tag name)]=[ISBN]

The invoked function set in association with this attribute name is set as a processing function for searching through online bookstores on which books including [attribute value (tag value)]=[book number] are listed and displaying a result of the search.

The processing of the service example 4, i.e., the processing for analyzing an extended tag such as [date:date] and displaying a bookmark in a calendar format is realized as described below.

Processing by the invoked function set in association with the extended tag [date:date] is as follows.

[attribute name (tag name)]=[date]

The invoked function set in association with this attribute name is set as a processing function for acquiring and displaying calendar information including [attribute value (tag value)]=[date] and displaying resource information associated the extended tag on a display calendar.

The processing of the service example 5, i.e., the processing for interpreting an extended tag such as [image:http://www . . . ] and performing data display including an image as bookmark information is realized as described below.

Processing by the invoked function set in association with the extended tag [image:http://www . . . ] is as follows.

[attribute name (tag name)]=[image]

The invoked function set in association with this attribute name is set as a processing function for acquiring image information designated by [attribute value (tag value)]=[http://www . . . ] and executing list display of the image information acquired.

In this way, it is possible to execute the various services according to the processing of the invoked functions that uses the extended tags (Richtags), i.e., [attribute name (tag name)]:[attribute value (tag value)]. In other words, it is possible to provide the user with various kinds of additional information by invoked functions set in advance in association with [attribute name (tag name)] of extended tags and executing processing of the invoked functions with [attribute value (tag value)] as input parameters.

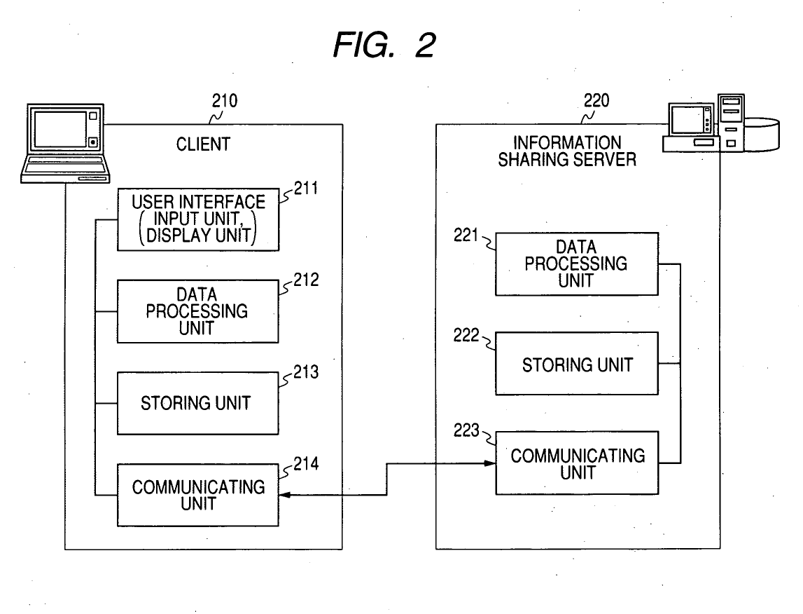

A constitution for realizing the services and the user interface described above will be hereinafter explained with reference to FIG. 2 and the subsequent figures. FIG. 2 is a block diagram showing one client 210 connected to a network and an, information sharing server 220 that holds bookmarks and extended tag information usable by various clients and holds functions corresponding to attribute names (tag names) of respective extended tags.

The client 210 includes a user interface 211 serving as a data input/output unit, a data processing unit 212, a storing unit 213, and a communicating unit 214. The information sharing server 220 includes a data processing unit 221, a storing unit 222, and a communicating unit 223. As a hardware configuration, these devices are realized by a configuration same as a general PC configuration. A specific example of the hardware configuration will be explained later.

The client 210 executes a browser serving as application software stored in the storing unit 213, i.e., application software for browsing Web pages in the data processing unit 212 and outputs various Web pages to a display unit that constitutes the user interface 211. The browser is application software for downloading an HTML file, an image file, a music file, and the like from the Internet and analyzing a layout to display and reproduce Web pages.

The data processing unit 212 of the client 210 executes various kinds of processing according to a program stored in the storing unit 213 other than processing for displaying Web pages. For example, the data processing unit 212 transmits data inputted by the user via the user interface 211 to a network-connected server and the like via the communicating unit 214 and causes an application such as Java® to operate. Moreover, the data processing unit 212 executes resource information registration processing (bookmark setting processing) as processing for recording an address (a URL) and the like of a Web site and processing for registering index information (a tag) corresponding to the resource information.

In the client 210, other than the bookmark setting processing, it is possible to set an extended tag (Richtag) of the [attribute name (tag name)]:[attribute value (tag value)] type as index information corresponding to the bookmark. Information on the bookmark and the extended tag set in the client 210 is transmitted to the information sharing server 220 via the communicating unit 214 and recorded in the storing unit 222 of the information sharing server 220.

Bookmarks and extended tag information set by a large number of network-connected clients are stored in the storing unit 222 of the information sharing server 220. These kinds of information are information that the large number of clients are capable of browsing. The information sharing server 220 provides a shared space freely accessible by the large number of clients and stores the bookmark and extended tag information set by the large number of clients in this shared space.

In the storing unit 222 of the information sharing server 220, registration information of a function corresponding to [attribute name (tag name)] of the extended tag described above, i.e., the extended tag having the structure of [attribute name (tag name)]:[attribute value (tag value)] is further recorded. The data processing unit 221 of the information sharing server 220 receives, for example, [attribute name (tag name)], which is structure of information of the extended tag, as input information of the client 210 via the communicating unit 223, invokes and executes a function corresponding to the attribute name received on the basis of a function registration table recorded in the storing unit 222, and transmits a result of the execution of the function to the client 210 via the communicating unit 223. The client 210 receives the function processing result from the information sharing server 220 and outputs a received result on the client side.

For example, in the case of the service example 1, the information sharing server 220 receives the extended tag [Location:135.00, 39.00], which is input information of the client 210, via the communicating unit 223 and invokes and executes a function recorded in the storing unit 222 in association with [attribute name (tag name)]:[Location] in the extended tag received. The function in this case is, for example, a function for executing processing for acquiring and displaying a map. As a parameter for determining an area of the map displayed, [attribute value (tag value)]=[135.00, 39.00], i.e., the latitude and longitude information is applied.

In this way, the information sharing server 220 determines a display map by executing the function based on the extended tag [Location:135.00, 39.00], acquires display map information from the storing unit or a map database on the network, and transmits acquisition information to the client 210 via the communicating unit 223. The client 210 receives a function processing result from the information sharing server 220 and outputs the received result on the client side. According to this processing, the client can display a map of an area specified on the basis of the extended tag [Location:135.00, 39.00] on a display on the client side.

The processing for executing the function may be performed on the client side. The data processing unit 221 of the information sharing server 220 invokes, on the basis of [attribute name (tag name)] received from the client 210, the function recorded in association with the attribute name from the storing unit 222 and transmits the acquired function itself to client 210 via the communicating unit 223. The client 210 executes the function received in the data processing unit on the client side and outputs a function processing result on the client side. In this processing sequence, it is also possible to display the map of the area specified on the basis of the extended tag [Location:135.00, 39.00] on the display on the client side.

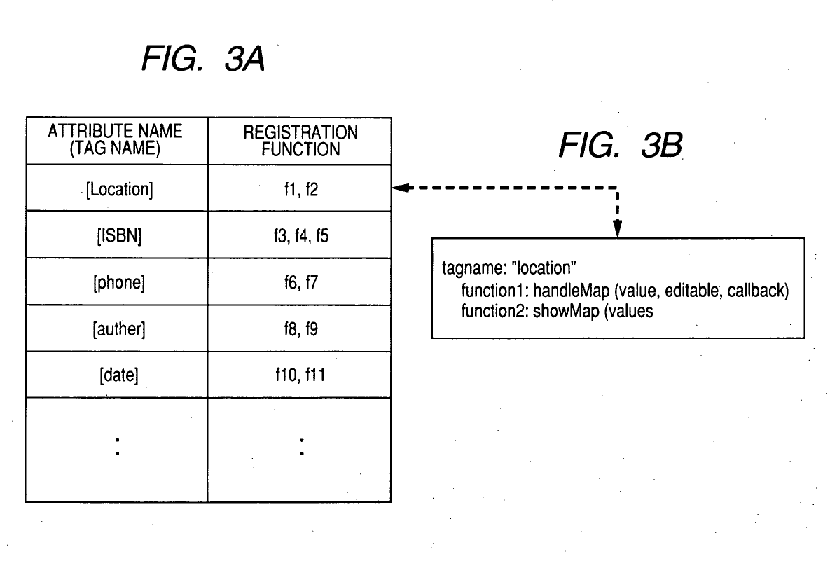

An example of a structure of the function registration table stored in the storing unit 222 of the information sharing server 220 will be explained with reference to FIGS. 3A and 3B. FIG. 3A shows an example of the function registration table stored in the storing unit 222 of the information sharing server 220. As shown in FIG. 3A, the function registration table is a table in which [attribute name (tag name)] serving as an element of an extended tag and a function are associated with each other.

For example, two functions f1 and f2 are registered as invoked functions for [attribute name (tag name)]=[Location]. According to execution of these functions, for example, map information corresponding to latitude and longitude information registered as [attribute value (tag value)] is acquired and subjected to display processing. As shown in FIG. 3A, functions corresponding to various kinds of [attribute name (tag name)] set as elements of extended tags are registered in the function registration table.

For example, plural functions f1 and f2 including the function for executing processing for acquiring and displaying a map are associated with [attribute name (tag name)]=[Location].

Functions f3 to f5 including, for example, a function for searching through online bookstores in which books including [attribute value (tag value)]=[book number] and executing processing for displaying a result of the search are associated with [attribute name (tag name)]=[ISBN].

Besides, functions corresponding to various kinds of processing to be executed are registered in association with various kinds of [attribute name (tag name)].

Plural functions are set for each of the kinds of [attribute name (tag name)]. These functions are selected according to a processing form on the client side.

It is possible to individually register functions executed according to respective processing forms such as functions described below.

A function executed on the client side when a bookmark list is displayed and an extended tag shown in the bookmark list is designated: fp

A function executed on the client side on the basis of [attribute name (tag name)] inputted when processing for registering a new extended tag is executed: fq

The information sharing server performs processing for selecting a function according to a page presented on the client side. For example, when the selection of a function is executed in the information sharing server 220, the information sharing server 220 receives [attribute name (tag name)] serving as an element of an extended tag inputted by the user on the client 210 side and selects, on the basis of [attribute name (tag name)] received, a function corresponding to a processing state (e.g., a type of a page presented on the client side and user operation) out of plural functions recorded in association with the attribute name from the function registration table of the storing unit 222.

As processing for the selected function, it is possible to perform processing for executing the function on the information sharing server and transmitting an execution result to the client or transmitting the function itself selected form the function registration table to the client and causing the client to execute the function. The function itself may be registered on the client side and the registered function may be invoked and executed on the client side.

A specific example of the two functions f1 and f2 registered for [attribute name (tag name)]=[Location] is shown in FIG. 3B. The functions f1 and f2 are set as functions described below. In this embodiment, a processing function is registered in order to provide an appropriate user interface and display format according to each kind of [attribute name (tag name)]. A set of [attribute name (tag name)] and the processing function is called Taglet. The Taglet has, for example, a registration format described below as shown in FIG. 3B.

tagname: “location”

function 1: handleMap (value, editable, callback)

function 2: showmap (values)

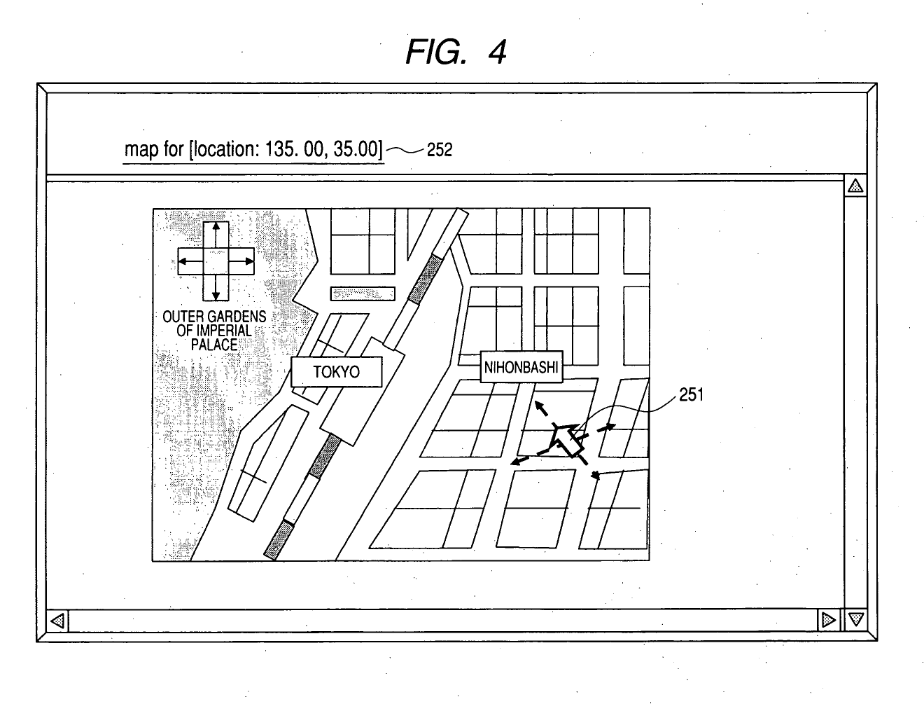

The tagname is [attribute name (tag name)] as an object and is [location] in the example described above. Two kinds of processing functions f1 (function 1) and f2 (function 2) are registered for this [attribute name (tag name)]=[Location]. The function f1 (function 1) is a function for creating, for respective tags, a (visual) representation easily understood by users. For example, the map display shown in FIG. 4 is executed from an extended tag representation having a data structure of [attribute name (tag name)] [attribute value (tag value)], [location:135.00. 35.00].

Moreover, for example, the data processing unit of the client serving as a function executing unit performs processing for changing a result of upper operation (mouse operation for changing a position on a map, etc.) on the map display data shown in FIG. 4 back to a character string representation according to callback. For example, when the user moves an arrow 251 shown in FIG. 4 with a mouse, the data processing unit executes processing for reflecting latitude and longitude information indicated by the arrow 251 on an attribute value data space 252 in an extended tag and displaying the information in accordance with the movement. This processing is used, for example, in setting a new extended tag. A specific processing example will be described later. With such a constitution, the user can treat a tag not only as a character string representation but also as a visual representation.

For example, when the functions f1 and f2 are registered for [attribute name (tag name)]=[Location], at a stage when the user creates a bookmark, inputs a tag, and inputs [location], the functions are invoked. In other words, a program for receiving a character string [location:xxx,yyy] and displaying the character string as a map is registered as the function f1 (the function 1).

Moreover, the user generates a character string representation of a tag anew by operating the map displayed and notifies the system of the character string representation through the function (callback). In this way, it is possible to register a different user interface in the system according to a type of a tag. It is possible to register this function not only in a system provider (an information sharing server, etc.) but also in a client apparatus on an end user side. This makes it possible to customize a display format corresponding to a type of a tag on the end user side.

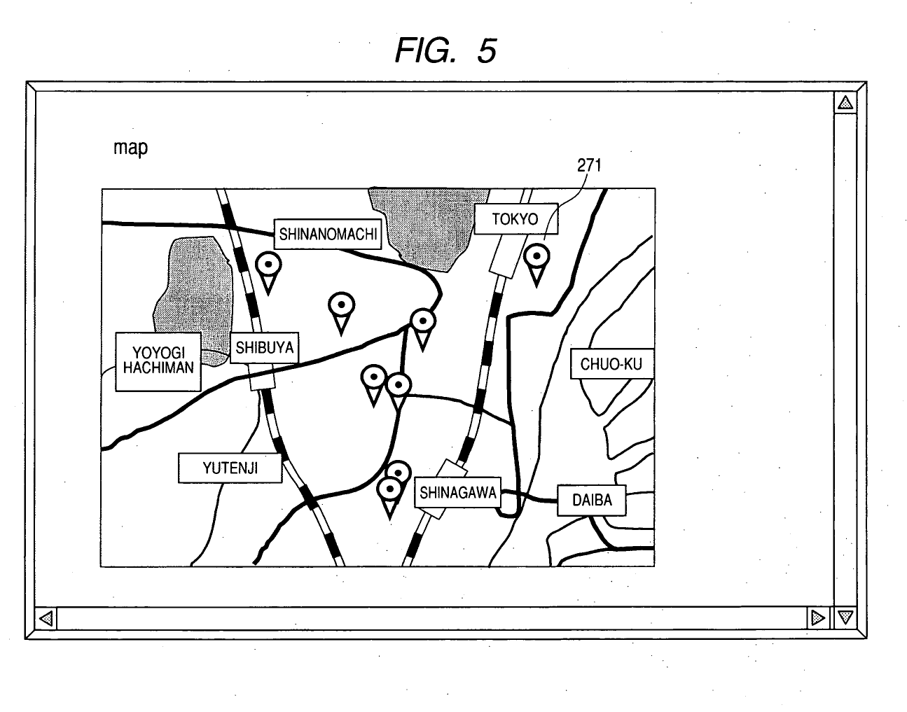

On the other hand, the other function f2 (the function 2) registered for [attribute name (tag name)]=[Location] is a function for providing a visual representation for a set of tags rather than for an individual extended tag. For example, a bookmark attached with [attribute name (tag name)]=[Location] is found from a set of plural bookmarks and the function f2 (the function 2) is invoked as an argument for plural extended tags of [attribute name (tag name)]=[Location] obtained as a result of the search. This makes it possible to provide, for example, data display shown in FIG. 5.

The data shown in FIG. 5 is data indicating what kind of distribution the tag information concerning a position, i.e., data having the structure of [attribute name (tag name)]=[Location] in a bookmark takes. A mark 271 in the figure indicates a position corresponding to [attribute value (tag value)] of each of plural extended tags having the structure of [attribute name (tag name)]=[Location]. Similarly, it is possible to perform processing for displaying a bookmark attached with an extended tag corresponding to a date such as [date:01/06/2006] in a calendar format.

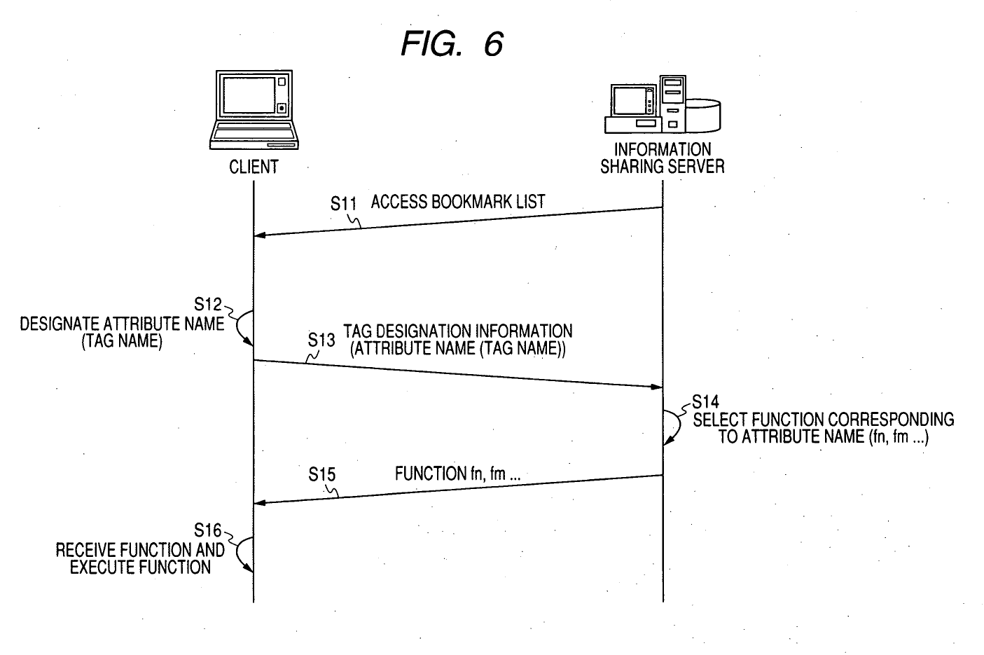

A specific processing example will be hereinafter explained with reference to FIG. 6. FIG. 6 is a diagram showing a processing sequence using an extended tag corresponding to a bookmark recorded in a bookmark list acquired by the client from the information sharing server. Various kinds of data processing explained in sequence charts below are executed in the data processing unit in the client on the client side and executed in the data processing unit in the server on the server side. Mutual data communication is executed via the communicating units of the server and the client.

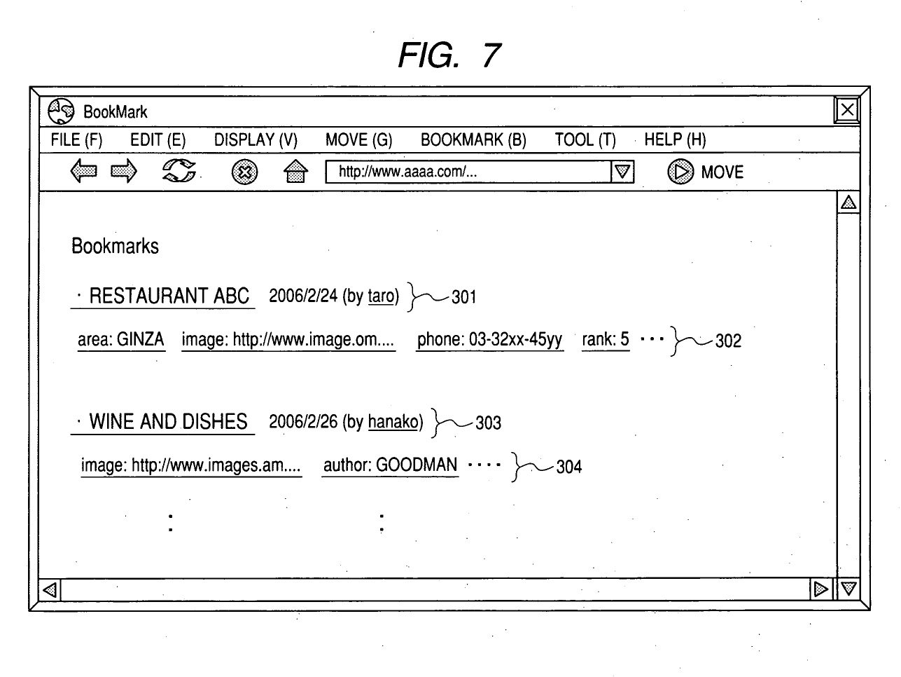

First, in step S1, the client acquires a bookmark list from the information sharing server and displays the bookmark list on the display of the client. For example, a bookmark list shown in FIG. 7 is displayed. As shown in FIG. 7, the bookmark list is a list including combinations of bookmarks set by various clients and extended tags (Richtags) associated with the respective bookmarks, i.e., extended tags having the structure of [attribute name (tag name)] [attribute value (tag value)].

In an example shown in FIG. 7, a bookmark 301, extended tags 302 corresponding to the bookmark 301, a bookmark 303, and extended tags 304 corresponding to the bookmark 303 are shown. The bookmarks 301 and 303 are associated with URLs of Web pages corresponding to the bookmarks, respectively. It is possible to invoke and display the Web pages corresponding to the bookmarks by clicking the bookmarks.

Extended tags corresponding to the bookmarks, i.e., extended tags (Richtags) of the [attribute name (tag name)]:[attribute value (tag value)] are set in the bookmarks 301 and 303. These extended tags are tags set as index information corresponding to the bookmarks by users.

In step S12 shown in FIG. 6, the client, which has acquired the bookmark list of such a structure, designates (e.g., by mouse click) an extended tag corresponding to a certain bookmark in the bookmark list displayed. Designation information of this extended tag is transmitted to the information sharing server in step S13.

In step S14, the data processing unit of the information sharing server searches through the function registration table, which is explained with reference to FIG. 3 above, on the basis of the [attribute name (tag name)] information included in reception information from the client and acquires functions (fn, fm, . . . ) corresponding to the [attribute name (tag name)] designated by the client. In step S15, this acquired function is transmitted to the client. In step S16, the client receives and executes the functions (fn, fm, . . . ).

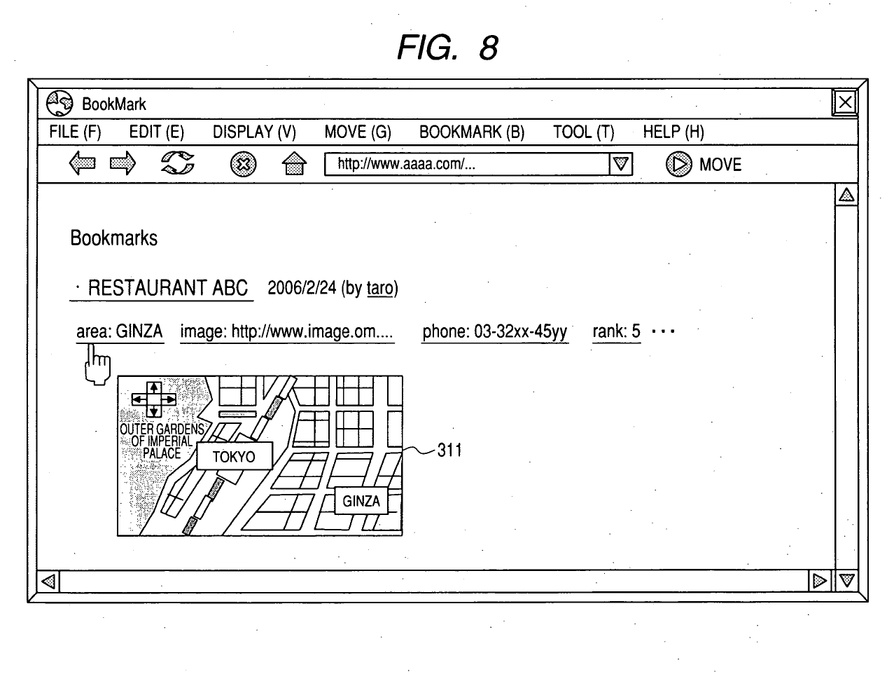

An example of the execution of a function will be explained. For example, an example of the execution of a function in the case in which one extended tag [area:Ginza] in the extended tags 302 set in association with the bookmark 301 shown in FIG. 7 is designated is shown in FIG. 8.

Processing by an invoked function set in association with the extended tag [area:Ginza] is as follows.

As described above, [attribute name (tag name)]=[area].

An invoked function set in association with this attribute name is a function for executing processing for displaying a map. In this case, as a parameter for determining an area of the map displayed, [attribute value (tag value)]=[Ginza] is used.

The data processing unit on the client side applies the parameter [Ginza] serving as the attribute value to the function selected and received in the information sharing server according to the attribute name [area] of the extended tag and acquires a map including Ginza. A map image 311 shown in FIG. 8 is displayed on the display. This map image 311 is information registered by the user who has set this extended tag. The series of processing is executed with the designation of an extended tag executed on the client side in step S12 shown in FIG. 6 as a trigger.

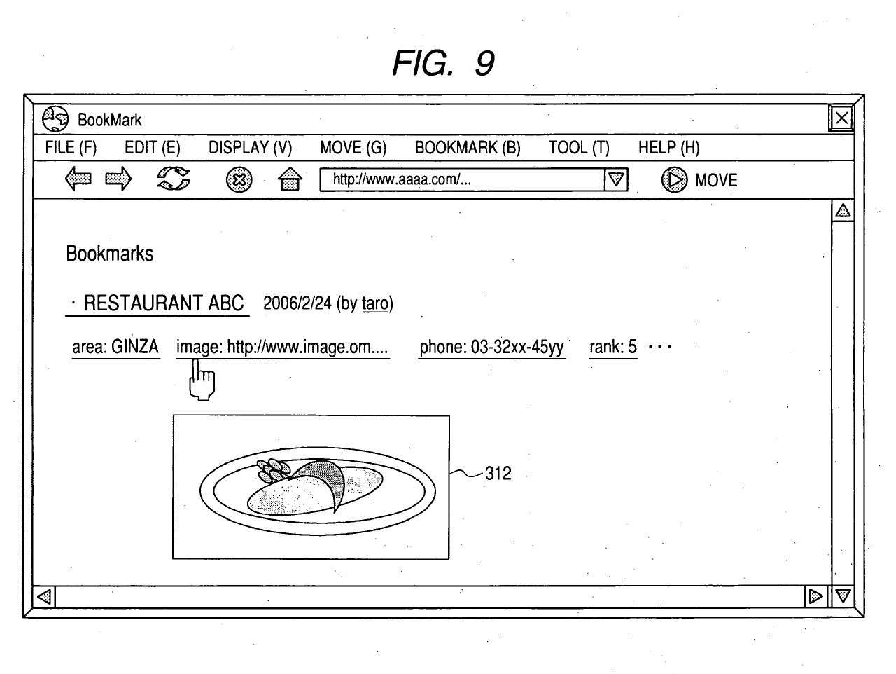

An example of the execution of a function in the case in which another extended tag [image:http://www.image.om . . . ] in the extended tags 302 set in association with the bookmark 301 shown in FIG. 7 is designated is shown in FIG. 9.

Processing by an invoked function set according to the extended tag [image:http://www.image.om . . . ] is as follows.

As described above, [attribute name (tag name)]=[image].

An invoked function set in association with this attribute name is a processing function for executing display of image information acquired by acquiring image information designated by [attribute value (tag value)]=[http//www . . . ].

The data processing unit on the client side acquires, on the basis of the function selected and received in the data processing unit of the information sharing server according to the attribute name [image] of the extended tag, the image information designated by [attribute value (tag value)]=[http//www . . . ] and executes display of the image information acquired. As a result, image data 312 of an omelet shown in the figure is displayed. This image is image information registered by a user who has set this extended tag.

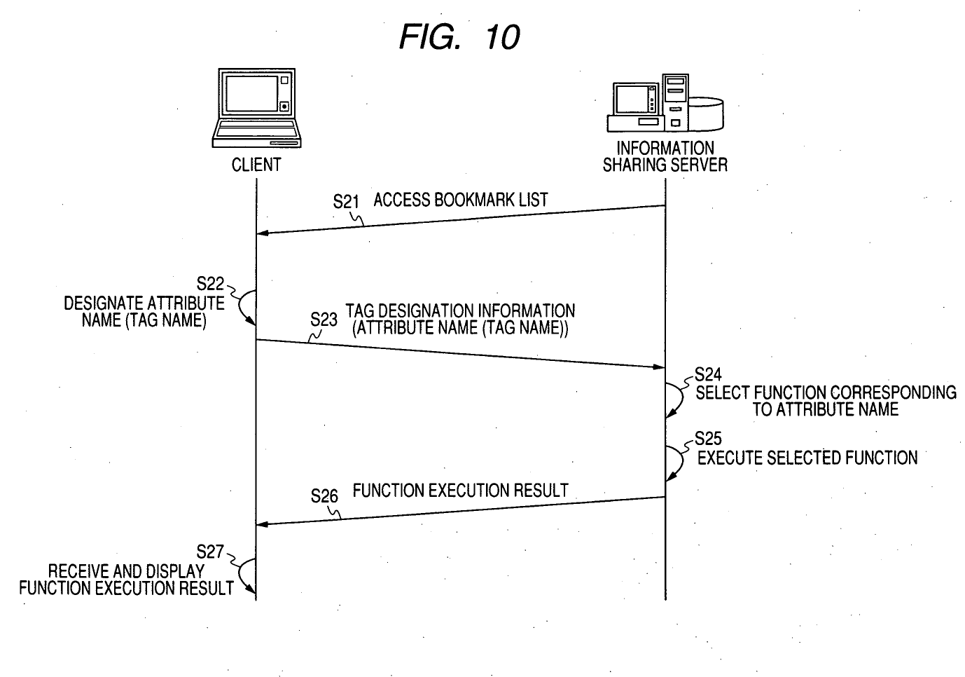

The processing example explained with reference to FIG. 6 is a processing example for executing only acquisition of an invoked function based on an extended tag in the data processing unit of the information sharing server and performing processing for executing the function on the data processing unit on the client side. However, as described above, it is also possible that execution of not only the acquisition of an invoked function based on an extended tag but also the function acquired is performed in the data processing unit of the information sharing server and a result of the execution is provided to the client. A processing sequence in the case of this processing will be explained with reference to FIG. 10.

First, in step S21, the client acquires a bookmark list from the information sharing server and displays the bookmark list on the display of the client. The bookmark list is the bookmark list explained with reference to FIG. 7 above, i.e., a list including combinations of bookmarks set by various clients and extended tags (Richtags) associated with the respective bookmarks, i.e., extended tags having the structure of [attribute name (tag name)]:[attribute value (tag value)]

In step S22 shown in FIG. 10, the client, which has acquired the bookmark list, designates (e.g., by mouse click) an extended tag corresponding to a certain bookmark from the bookmark list displayed. In step S23, designation information of this extended tag is transmitted to the information sharing server.

In step S24, the information sharing server searches through, on the basis of [attribute name (tag name)] included in information received from the client, the function registration table explained with reference to FIG. 3 and acquires functions (fn, fm, . . . ) corresponding to [attribute name (tag name)] designated by the client. In step S25, the information sharing server further executes the acquired functions (fn, fm, . . . ). In step S26, the information sharing server transmits a result of the execution of the functions to the client. In step S27, the client receives and displays the result of the execution of the functions. In the case of this processing, information presented to the client is, for example, the same as the information explained with reference to FIGS. 9 and 10.

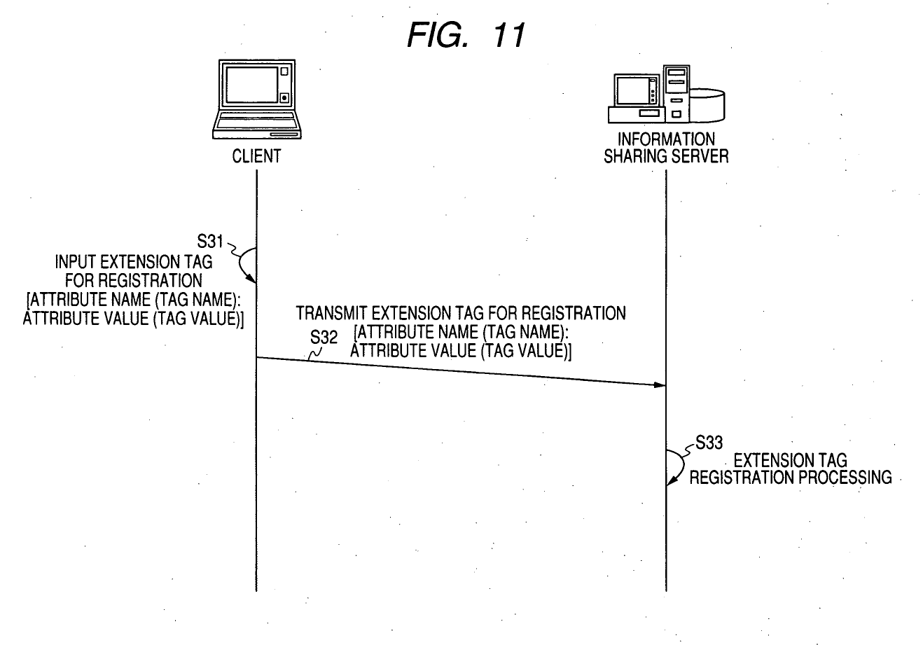

Processing for setting an extended tag (Richtag) of the [attribute name (tag name)]:[attribute value (tag value)] type will be explained with reference to FIG. 11 and the subsequent figures. The user can freely perform setting and registration of a bookmark and setting of an extended tag (Richtag) of the [attribute name (tag name)]:[attribute value (tag value)] type. Information of this setting is registered in the information sharing server and various users can freely use the information.

A sequence chart shown in FIG. 11 shows a basic sequence of processing for registering a new extended tag. First, in step S31, the client inputs extended tags (Richtags) of the [attribute name (tag name)]:[attribute value (tag value)] type in a bookmark-and-extended-tag-registration page provided by the information sharing server. For example, as described above, extended tags described below are inputted.

(1) Location:135.00, 39.00

(2) ISBN:000111222

(3) phone:03-5448-4380

(4) author:Jun Rekimoto

(5) date:2006/01/21

(6) area:Gotanda

(7) rank:5

(8) mail:foo@mailhost.com

(9) ref:http://other.com/another.html

(10) image:http://aaa.bbb.com/photo.jpg

In step S32, the extended tags (Richtags) of the [attribute name (tag name)]:[attribute value (tag value)] type inputted by the client are transmitted to the information sharing server. In step S33, the information server executes registration processing for storing the new extended tags set by the client in the storing unit and setting the extended tags usable as shared information. According to such registration of the new extended tags, tags usable as index information of bookmarks increase.

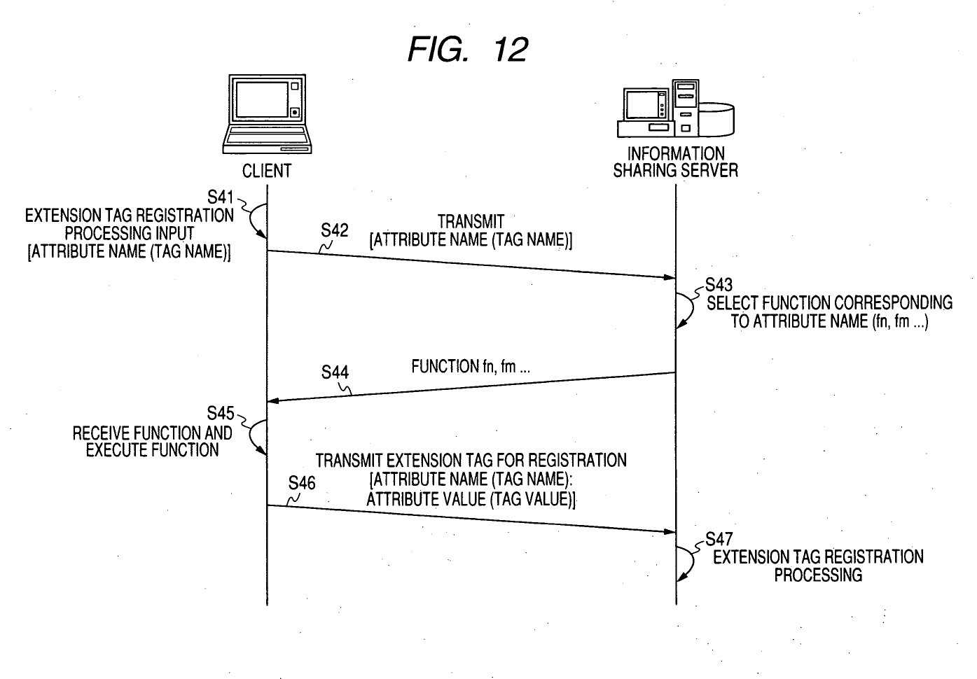

In the processing for registering the new extended tags, it is possible to make tag registration processing by the user efficient according to the execution of a function. An example of function use processing at the time of the registration of the extended tags will be explained with reference to FIG. 12 and the subsequent figures.

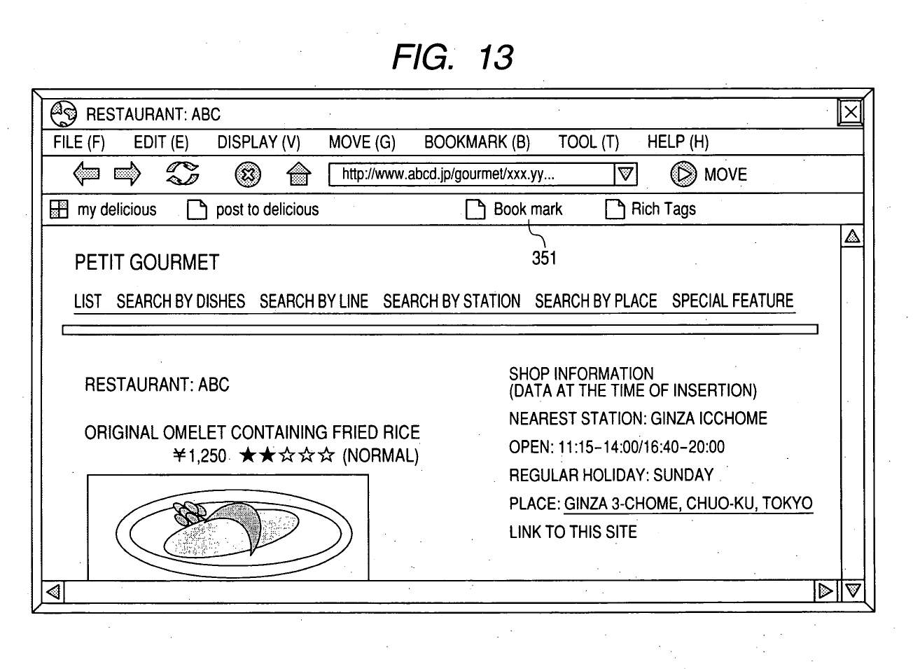

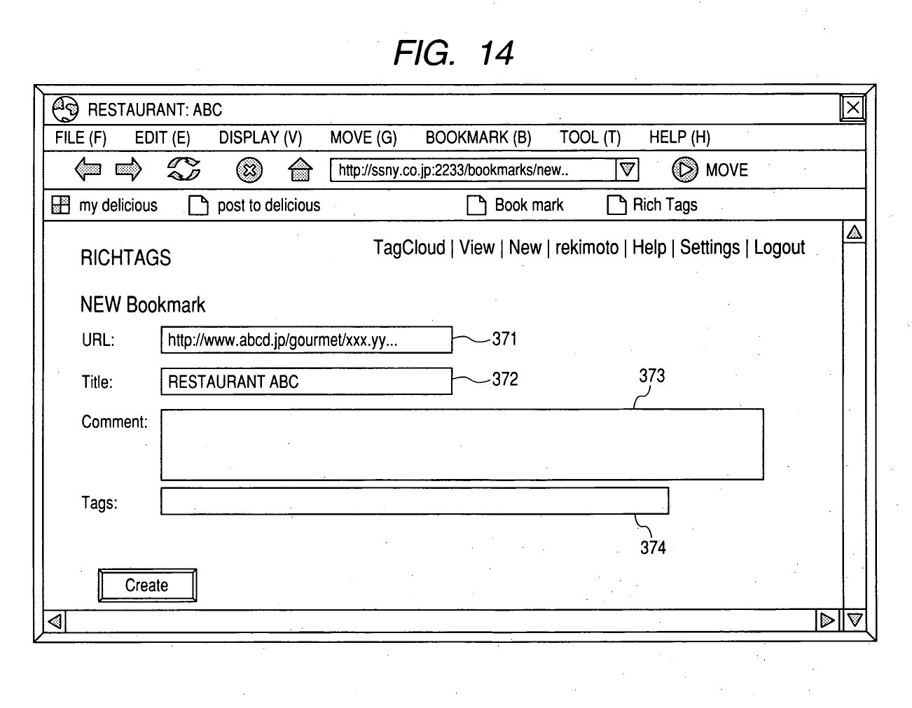

First, in step S41, the client presents a bookmark-and-extended-tag-registration page provided by the information sharing server on the display on the client side. A procedure for invoking the bookmark-and-extended-tag-registration page will be explained with reference to FIGS. 13 and 14.

The user browses various Web pages via the network and performs processing for setting a bookmark on a favorite Web page. For example, when the user browses a Web page of a restaurant ABC shown in FIG. 13 and sets a bookmark on this Web page, the user invokes a bookmark setting processing program, which is a program set as a function associated with the browser. The user clicks a bookmark [Bookmark] button shown in FIG. 13 to present the bookmark-and-extended-tag-registration page on the display of the client.

An example of a structure of the bookmark-and-extended-tag-registration page is shown in FIG. 14. As shown in FIG. 14, a URL setting space 371 for a Web page for which a bookmark is set, a title space 372, a comment space 373, and an extended tag setting space 374 are provided in the bookmark-and-extended-tag-registration page.

A URL and a title corresponding to a Web page just browsed by the user are displayed in the Web page URL setting space 371 and the title space 372. The user can input a URL and a title anew. The user can freely write a comment in the comment space 373 and input an extended tag (Richtag) having the data format of [attribute name (tag name)]:[attribute value (tag value)] in the extended tag setting space 374.

In step S41 of the sequence chart shown in FIG. 12, the user on the client side displays the bookmark-and-extended-tag-registration page shown in FIG. 14 on the display on the client side and inputs an extended tag (Richtag) having the data format of [attribute name (tag name)]:[attribute value (tag value)] in the extended tag setting space 374. First, the user inputs [attribute name (tag name)] in the extended tag setting space 374.

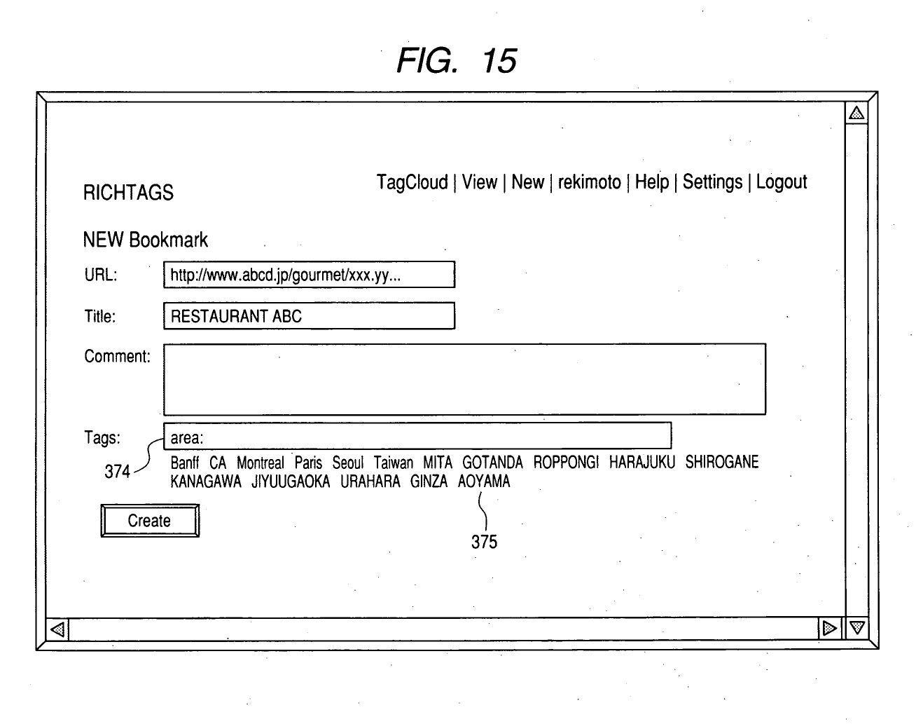

For example, as shown in FIG. 15, the user inputs [area] as [attribute name (tag name)]. Input information of this [attribute name (tag name)] is sent to the information sharing server in step S42 of the sequence chart shown in FIG. 12. In step S431 the information sharing server selects a function set in association with [attribute name (tag name)]=[area] from the function registration table explained with reference to FIG. 3 above. In step S44, the information sharing server transmits the selected function to the client. In step S45, the client executes the function.

The processing function in this case is a processing function for searching for a bookmark with [area] set as [attribute name (tag name)], acquiring an extended tag [area:***] corresponding to the bookmark obtained as a result of the search, and acquiring [attribute value (tag value)] set in the extended tag to display [attribute value (tag value)] as a list. As a result of execution of this function, a place name list 375 shown in FIG. 15 is presented. These kinds of information are attribute-value-setting-support information.

The client can select an arbitrary place name from the place name list 375 and record [attribute value (tag value)] corresponding to [attribute name (tag name)]=[area] in the extended tag setting space 374.

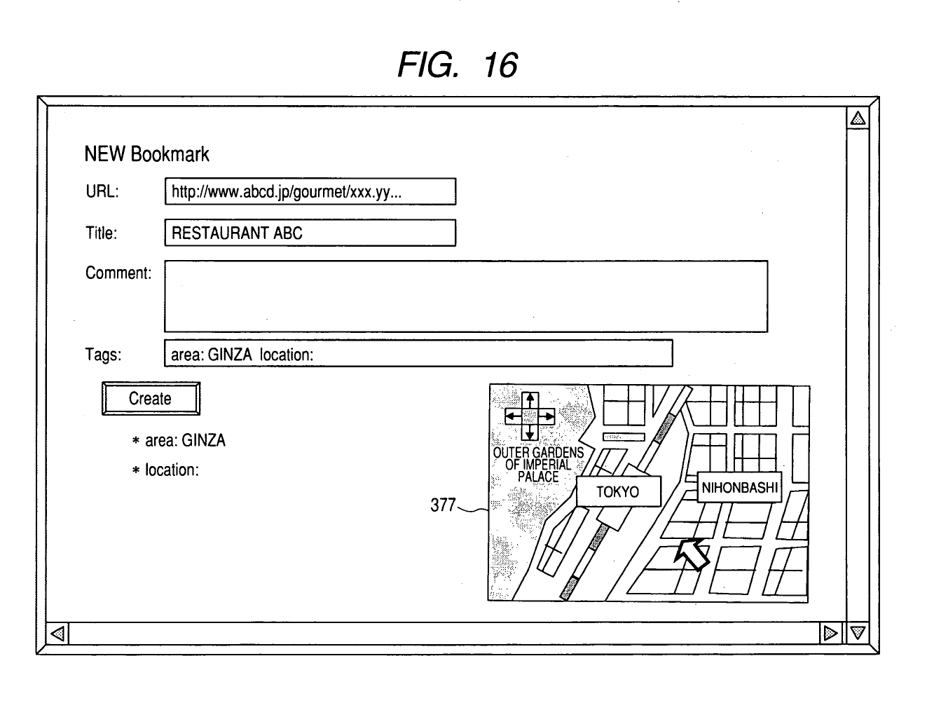

Subsequently, as shown in FIG. 16, the user inputs [location] as [attribute name (tag name)]. Input information of this [attribute name (tag name)] is also sent to the information sharing server. The information sharing server selects a function set in association with [attribute name (tag name)]=[location] from the function registration table explained with reference to FIG. 3 above and transmits the selected function to the client. The client executes the function.

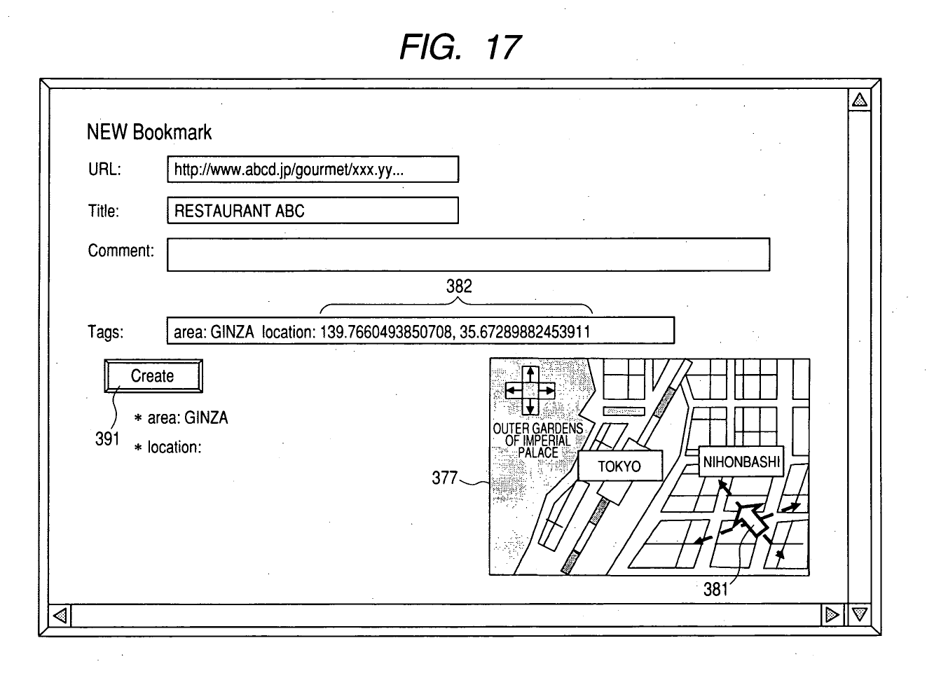

The processing function in this case is an invoked function corresponding to [attribute name (tag name)]=[location]. The processing function is executed as map display processing and a map image 377 shown in FIG. 16 is displayed. The user operates this map image with the mouse to select a specific location. For example, as shown in FIG. 17, the user moves an arrow 381 by operating the mouse. The function invoked in association with [attribute name (tag name)]=[location] executes, on the basis of this user operation information, processing for reflecting latitude and longitude information indicated by the arrow 381 on an attribute value data space 382 in the extended tag and displaying the latitude and longitude information. These kinds of information are attribute-value-setting-support information. According to this processing, the user can easily set the latitude and longitude information as an attribute value corresponding to [attribute name (tag name)]=[location].

When the entry of these extended tags is finished, the user clicks a create button 391 shown in FIG. 17. According to this click processing, the extended tag information recorded in the extended tag setting space 374 by the user is transmitted to the information sharing server and registered in the storing unit of the information sharing server. In other words, processing in steps S46 and S47 of the sequence chart shown in FIG. 12 is executed and the setting and registration of the new extended tag is completed.

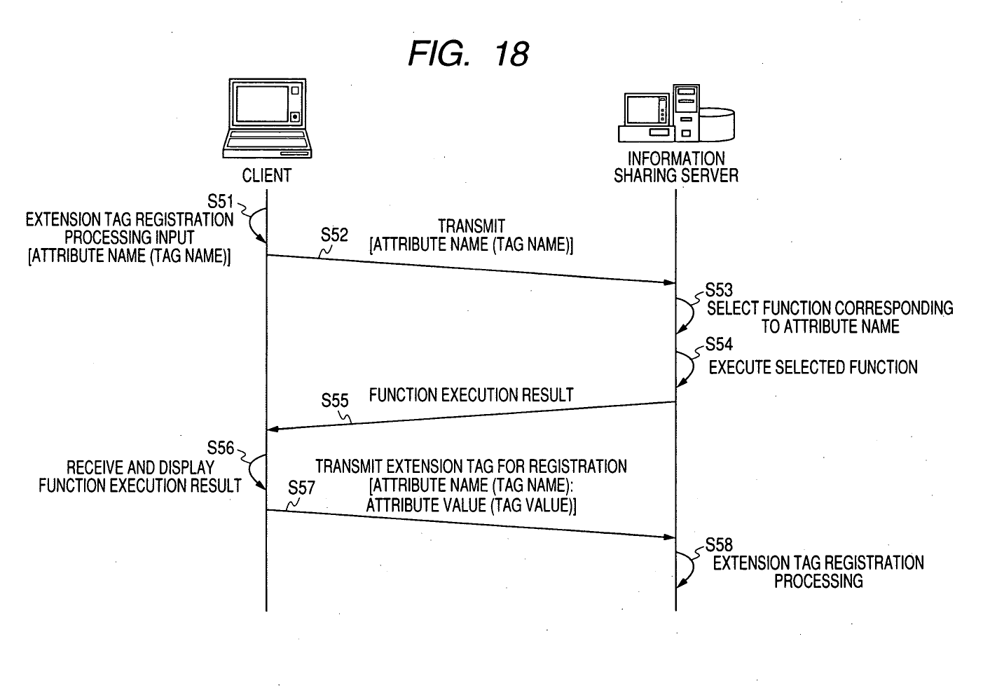

In this extended tag registration processing, an entity that executes the function may be the client or the information sharing server. In an example explained in the sequence chart shown in FIG. 12, the client is the entity that executes the function. However, when the function is executed in the information sharing server, processing complying with a sequence chart shown in FIG. 18 is executed.

In step S51, the client presents a bookmark-and-extended-tag-registration page provided by the information sharing server on the display on the client side. This bookmark-and-extended-tag-registration page is a page explained with reference to FIG. 14 above.

The user inputs [attribute name (tag name)] in the extended tag setting space 374 in the page explained with reference to FIG. 14. In step S52, information on this input is sent to the information sharing server. In step S53, the information sharing server selects a function set in association with [attribute name (tag name)] from the function registration table explained with reference to FIG. 3 above. In step S54, the information sharing server executes the selected function. In step S55, the information sharing server transmits a result of the execution of the function to the client.

In step S56, the client receives the function execution result and outputs the function execution result to the display on the client side. An example of this output is the same as the example explained with reference to FIGS. 16 and 17 above.

When the entry of the extended tag is finished, the user clicks the create button 391 shown in FIG. 17. According to this click processing, the extended tag information recorded in the extended tag setting space by the user is transmitted to the information sharing server and registered in the storing unit of the information sharing server. In other words, processing in steps S57 and S58 in the sequence chart shown in FIG. 18 is executed and the setting and registration of the new extended tag is completed.

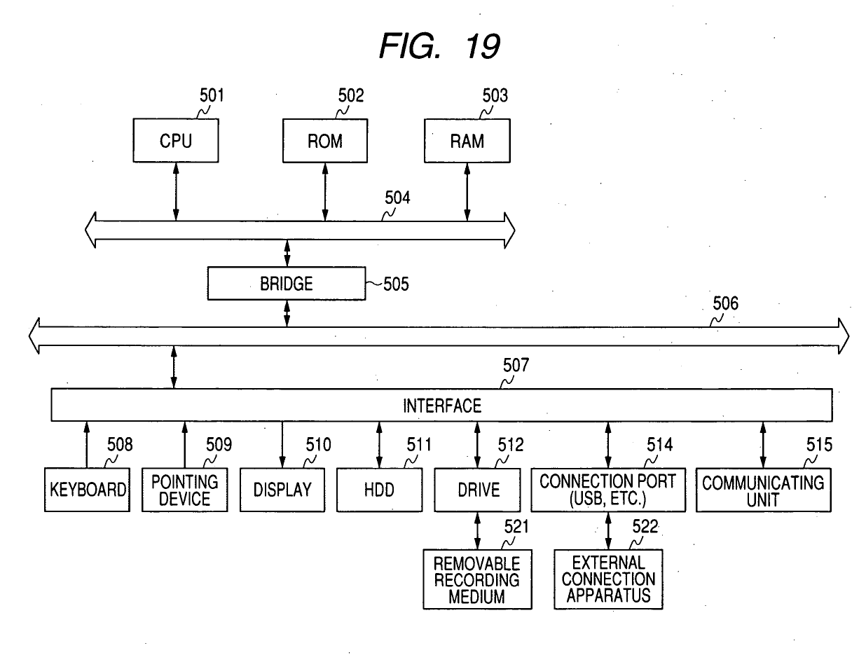

An example of a structure of hardware of information processing apparatuses constituting the client and the information sharing server, which constitute the system that executes the processing described above, will be explained with reference to FIG. 19. A CPU (Central Processing Unit) 501 functions as an entity of execution of processing corresponding to an OS (Operating System) and the data processing unit explained in the embodiment and performs processing for selecting a function, processing for executing the function, data communication processing control, and the like. These kinds of processing are executed in accordance with computer programs stored in ROMs of the respective information processing apparatuses and the data storing unit such as a hard disk.

A ROM (Read Only Memory) 502 stores programs, arithmetic operation parameters, and the like used by the CPU 501. A RAM (Random Access Memory) 503 stores programs used in execution of the CPU 501 and parameter and the like that change as appropriate in the execution. The CPU 501, the ROM 502, and the RAM 503 are connected to one another by a host bus 504 including a CPU bus.

The host bus 504 is connected to an external bus 506 such as a PCI (Peripheral Component Interconnect/Interface) bus via a bridge 505.

A keyboard 508 and a pointing device 509 are input devices operated by the user. A display 510 includes a liquid crystal display device or a CRT (Cathode Ray Tube) and displays various kinds of information as texts and images.

An HDD (Hard Disk Drive) 511 includes a hard disk, drives the hard disk, and records or reproduces programs executed by the CPU 501 and information. The hard disk is used for, for example, means for storing bookmarks, registration information of extended tags, a function registration table, and the like. Moreover, various computer programs such as a data processing program are stored in the hard disk.

A drive 512 reads out data or a program recorded in a removable recording medium 521 such as a magnetic disk, an optical disk, a magneto-optical disk, or a semiconductor memory inserted therein and supplies the data or the program to the RAM 503 connected thereto via an interface 507, the external bus 506, the bridge 505, and the host bus 504.

A connection port 514 is a port that connects an external connection apparatus 522 and has connecting sections for USB, IEEE1394, and the like. The connection port 514 is connected to the CPU 501 and the like via the interface 507, the external bus 506, the bridge 505, the host bus 504, and the like. A communicating unit 515 is connected to the network and executes communication with the client and a network connection server.

The example of the structure of the hardware of the information processing apparatus shown in FIG. 19 is an example of an apparatus constituted by applying a PC. In the system according to this embodiment, it is possible to apply not only the structure shown in FIG. 19 but also an apparatus that is capable of executing the processing explained in the embodiment.

The invention has been explained in detail with reference to the specific embodiment. However, it is obvious that those skilled in the art can perform alterations and substitutions of the embodiment without departing from the spirit of the invention. The invention is disclosed in a form of illustration and should not be interpreted limitedly. To determine the gist of the invention, the appended claims should be taken into account.

It is possible to execute the series of processing using hardware, software, or a combination of the hardware and the software. When processing by the software is executed, it is possible to install a program having recorded therein a processing sequence in a memory in a computer built in dedicated hardware to cause the computer to execute the program or install the program in a general-purpose computer capable of executing various kinds of processing to cause the computer to execute the program.

For example, it is possible to record the program in a hard disk or a ROM (Read Only Memory) serving as a recording medium in advance. Alternatively, it is possible to temporarily or permanently store (record) the program in a removable recording medium such as a flexible disk, a CD-ROM (Compact Disc Read Only Memory), an MO (Magneto optical) disk, a DVD (Digital Versatile Disc), a magnetic disk, or a semiconductor memory. It is possible to provide such a removable recording medium as so-called package software.

It is possible to install the program in the computer from the removable recording medium. Besides, it is possible to transfer the program from a download site to the computer by radio or transfer the program to the computer by wire via a network such as a LAN (Local Area Network) or the Internet. The computer can receive the program transferred in that way and install the program in a recording medium such as a hard disk built therein.

The various kinds of processing described in the specification is not only executed in time series in accordance with the description but also executed in parallel or individually according to a processing ability of an apparatus that executes the processing or when necessary. In this specification, the system is a logical collection of plural apparatuses and is not limited to a system in which apparatuses of various structures are stored in an identical housing.

As explained above, according to the embodiment of the invention, an extended tag (Richtag) including a combination of an attribute name (a tag name) and an attribute value (a tag value) is used as index information corresponding to a bookmark serving as URL registration information of a Web page, a function corresponding to the attribute name that is an element of the extended tag is set and registered, and a function corresponding to an attribute name designated by a user is acquired and executed. Consequently, it is possible to perform, for example, processing for displaying a map corresponding to latitude and longitude information set as an attribute name with respect to an attribute name [location] indicating a location and processing for acquiring and displaying an image corresponding to an image information address (URL) set as an attribute value with respect to an attribute name [image] indicating image information.

It should be understood by those skilled in the art that various modifications, combinations, sub-combinations, and alterations may occur depending on design requirements and other factors insofar as they are within the scope of the appended claims or the equivalents thereof.

What is claimed is:

1. An information processing apparatus comprising:
a user interface serving as a data input/output unit;
a communicating unit that executes data communication; and
a data processing unit that executes bookmark setting processing serving as Web page browsing processing and URL (Uniform Resource Locator) registration processing of a Web page, wherein
the data processing unit acquires and executes a function corresponding to an attribute name that is an element of an extended tag including a combination of an attribute name and an attribute value set as index information corresponding to a bookmark or acquires an execution result of the function corresponding to the attribute name and outputs the execution result of the function to the user interface.

2. An information processing apparatus according to claim 1, wherein the data processing unit transmits extended tag structure information, which is inputted or designated via the user interface, to a server via the communicating unit, receives a function, which is registered as an attribute-name-corresponding function in a function registration table held by the server, from the server via the communicating unit and executes the function, and outputs an execution result of the function to the user interface.

3. An information processing apparatus according to claim 1, wherein the data processing unit executes processing for transmitting extended tag structure information, which is inputted or designated via the user interface, to a server via the communicating unit, receiving an execution result of a function, which is registered as an attribute-name-corresponding function in a function registration table held by the server, from the server via the communicating unit, and outputting the function execution result received to the user interface.

4. An information processing apparatus according to claim 1, wherein the data processing unit executes a function set in association with an attribute name in an extended tag by applying an attribute value in the extended tag to the function or acquires a function execution result obtained by executing the function by applying the attribute value in the extended tag to the function and outputs the function execution result to the user interface.

5. An information processing apparatus according to claim 1, wherein the data processing unit executes, on the basis of user input information corresponding to information presented on the user interface as the function execution result, processing for displaying information corresponding to the user input on the user interface.

6. An information processing apparatus according to claim 5, wherein the information displayed on the user interface in association with the user input is attribute-value-setting-support information at the time of setting of a new extended tag.

7. An information processing apparatus comprising:
a storing unit having stored therein a bookmark serving as URL (Uniform Resource Locator) registration information of a Web page, registration information of an extended tag that is index information corresponding to the bookmark and includes a combination of an attribute name and an attribute value, and a function registration table in which a function corresponding to the attribute name is registered;
a communicating unit that executes data communication; and
a data processing unit that executes processing for presenting the bookmark and a list of extended tags in response to a client request received via the communicating unit, wherein
the data processing unit inputs extended tag structure information from a client, acquires, on the basis of an attribute name included in the extended tag structure information, a registered function corresponding to the attribute name from the function registration table, and outputs the function acquired or a function execution result obtained by executing the function acquired to the client via the communicating unit.

8. An information processing apparatus according to claim 7, wherein the data processing unit executes, in executing the registered function corresponding to the attribute name acquired from the function registration table, the registered function as function execution processing to which an attribute value in the extended tag structure information received from the client is applied.

9. An information processing system comprising a client and a server that are capable of performing data communication with each other, wherein
a data processing unit of the client executes processing for transmitting structure information of an extended tag including a combination of an attribute name and an attribute value set as index information corresponding to a bookmark serving as URL (Uniform Resource Locator) registration information of a Web page to a server via a client communicating unit,
a data processing unit of the server executes processing for acquiring, on the basis of the attribute name included in the extended tag structure information received from the client, a registered function corresponding to the attribute name from a function registration table in which an attribute name and a corresponding function stored in a server storing unit are registered and outputting the function acquired or a function execution result obtained by executing the function acquired to the client via a server communicating unit, and
the data processing unit of the client executes processing for outputting a function execution result obtained by executing the function received from the server or the function execution result received from the server to a user interface on the client side.

10. A data structure of an extended tag including a combination of an attribute name and an attribute value set as index information corresponding to a bookmark serving as URL (Uniform Resource Locator) registration information of a Web page, wherein
the attribute name is information applied to selection of a function registered in association with the attribute name in a data processing unit in an information processing apparatus, and
the attribute value is a value having an attribute defined by the attribute name and is a value applied when the data processing unit executes the function registered in association with the attribute name.

11. An information processing method executed in an information processing apparatus, the information processing method comprising the steps of:
performing, in a data processing unit, function acquisition execution processing for acquiring and executing a function corresponding to an attribute name that is an element of an extended tag including a combination of an attribute name and an attribute value set as index information corresponding to a bookmark serving as URL (Uniform Resource Locator) registration information of a Web page or function execution result acquisition processing for performing acquisition of an execution result of the function corresponding to the attribute name; and
outputting, in the data processing unit, the function execution result to a user interface.

12. An information processing method according to claim 11, wherein the function processing step includes the steps of:
transmitting extended tag structure information inputted or designated via the user interface to a server via a communicating unit; and
receiving a function registered as an attribute-name-corresponding function in a function registration table held by the server from the server via the communicating unit and executing the function.

13. An information processing method according to claim 11, wherein the function processing step includes the steps of:
transmitting extended tag structure information inputted or designated via the user interface to a server via a communicating unit; and
receiving an execution result of a function registered as an attribute-name-corresponding function in a function registration table held by the server from the server via the communicating unit.

14. An information processing method according to claim 11, wherein the function processing step is a step of executing a function set in association with the attribute name in the extended tag by applying the attribute value in the extended tag to the function or acquiring a function execution result obtained by executing the function by applying the attribute value in the extended tag to the function.

15. An information processing method according to claim 11, further comprising the step of executing, in the data processing unit, on the basis of user input information corresponding to information presented on the user interface as the function execution result, processing for displaying information corresponding to the user input on the user interface.

16. An information processing method according to claim 15, wherein the information displayed in association with the user input on the user interface is attribute-value-setting-support information at the time of setting of a new extended tag.

17. An information processing method executed in an information processing apparatus, the information processing method comprising the steps of:
inputting, in a communicating unit, extended tag structure information including a combination of an attribute name and an attribute value as index information corresponding to a bookmark serving as URL (Uniform Resource Locator) registration information of a Web page from a client; and
executing, in a data processing unit, processing for acquiring, on the basis of the attribute name included in the extended tag structure information, a registered function corresponding to the attribute name from a function registration table in which an attribute name and a corresponding function stored in a storing unit are registered and outputting the function acquired or a function execution result obtained by executing the function acquired to the client via the communicating unit.

18. An information processing method according to claim 17, wherein the function processing step is a step of, in executing the registered function corresponding to the attribute name acquired from the function registration table, executing the registered function as function execution processing to which the attribute value in the extended tag structure information received from the client is applied.

19. A computer program that causes an information processing apparatus to execute information processing, the computer program causing the information processing apparatus to execute the steps of:
performing, in a data processing unit, function acquisition execution processing for acquiring and executing a function corresponding to an attribute name that is an element of an extended tag including a combination of an attribute name and an attribute value set as index information corresponding to a bookmark serving as URL (Uniform Resource Locator) registration information of a Web page or function execution result acquisition processing for performing acquisition of an execution result of the function corresponding to the attribute name; and
outputting, in the data processing unit, the function execution result to a user interface.

20. A computer program that causes an information processing apparatus to execute information processing, the computer program causing the information processing apparatus to execute the steps of:
inputting, in a communicating unit, extended tag structure information including a combination of an attribute name and an attribute value as index information corresponding to a bookmark serving as URL (Uniform Resource Locator) registration information of a Web page from a client; and
executing, in a data processing unit, processing for acquiring, on the basis of the attribute name included in the extended tag structure information, a registered function corresponding to the attribute name from a function registration table in which an attribute name and a corresponding function stored in a storing unit are registered and outputting the function acquired or a function execution result obtained by executing the function acquired to the client via the communicating unit.
